(19) United States
(12) Patent Application Publication
(10) Pub. No.: US 2006/0156072 A1
(43) Pub. Date: Jul. 13, 2006

(54) System and method for monitoring a computer apparatus

(76) Inventors: Prakash Khot, Burlington, MA (US); Rutvik Doshi, Framingham, MA (US); Kartik Shankaranarayanan, Framingham, MA (US); Rajendra Jodhapurkar, Framingham, MA (US); Silvio DeVincentis, Billerica, MA (US)

Correspondence Address: RICHARD F. JAWORSKI;Cooper & Dunham LLP, 1185 Avenue of the Americas, New York, NY, 10036, US

(21) Appl. No.: 11/186,565

(22) Filed: Jul. 21, 2005

Related U.S. Application Data
(63) Continuation of application No. 10/990,241, filed on Nov. 16, 2004, now abandoned.
Application No. 10/990,241 is a continuation of application No. 10/756,056, filed on Jan. 10, 2004, now abandoned.

(51) Int. Cl. G06F 11/00

(52) U.S. Cl. 714/47

(57) ABSTRACT

A method and system for monitoring a computer application, including selecting the computer application, inputting condition information, monitoring the computer application and generating an alert when a condition of the selected computer application satisfies the condition information. The monitoring step may be accomplished by inserting dynamic watchers into 1 byte code of the computer application that generates notification messages upon occurrence of certain events. The data included in the notification messages may be used to determine the value of selected parameters related to the computer application which is then compared to threshold levels input by the user as part of the condition information to determine a condition of the computer application. The alert is generated when the condition of the computer application indicates that there is a problem and that an alert is to be generated.

### REFERENCE TO RELATED APPLICATIONS

The present specification is based on and claims the benefit of Provisional Application 60/373,959 filed Apr. 19, 2002, the entire contents of which are herein incorporated by reference

### BACKGROUND

1. Technical Field

The present disclosure relates to computer applications. More specifically, the present disclosure relates to a method and system for real time transaction monitoring of a computer application.

2. Description of the Related Art

The Java (TM) 2 Platform, Enterprise Edition (J2EE) is the standard for developing multi-tier enterprise applications. J2EE bases enterprise applications on standardized, modular components, provides a set of services to those components, and handles many details of application behavior automatically, without complex programming.

Servlet technology provides web developers with a simple, consistent mechanism for extending the functionality of a web server and for accessing existing business systems. A servlet can almost be thought of as an applet that runs on the server side—without a face. Java servlets have made many web applications possible.

There are two kinds of Enterprise Java Beans (EJBs), “Entity Beans” and “Session Beans”. Java programmers are already familiar with objects. An entity bean is an object with special properties. Standard Java objects may be permanent, that is, the objects come into existence when they are created in a program. When the program terminates, the object may be lost. But an entity bean may exist until it is deleted. A program may create an entity bean, then the program can be stopped and restarted. The entity bean will continue to exist. After being restarted, the program can again find the entity bean, and continue using the same entity bean. An entity bean may be used by any program on the network.

In practice, entity beans maybe backed up by some kind of permanent storage, typically a database. Methods of an entity bean may run on a “server” machine. When an entity bean's method is called, a program's thread stops executing and control passes over to the server. When the method returns from the server, the local thread resumes executing. Entity Beans may have a primary key. The primary key is unique, i.e. each entity bean is uniquely identified by its primary key. For example, an “employee” entity bean may have Social Security numbers as primary keys.

Session beans may be different from entity beans in that they are not permanent objects. They are also not shareable in general, though it may be possible to share them by using their “handles”. Session beans can be used to distribute and isolate processing tasks. Each session bean may be used to perform a certain task on behalf of its client. The tasks may be distributed on different machines.

Enterprises focused on web application implementations and deployment may require an environment addressing the management issues of the health, availability, and performance of applications to make them an integral and well-behaved part of the mission-critical IT infrastructure.

Modern, service-oriented enterprises are built upon a complex web of hardware and software components. Web applications built for these enterprises may be layered, interconnected, and often highly distributed. The very architectural nature of web applications may present a serious challenge in isolating and resolving problems that address the management issues of health, availability and performance.

One of the factors considered when monitoring the availability and performance of web applications and underlying application server infrastructure is the use of real-time transaction monitoring versus synthetic transaction monitoring. Synthetic transaction monitoring proactively monitors web applications and allows prevention of error or failure before detection by an end-user. However, synthetic transaction monitoring does not address issues of performance and availability of real-time transactions. In other words, synthetic transaction monitoring does not effectively monitor the real-time condition of a server while executing a given application.

Accordingly it would be beneficial to provide a method and system for monitoring computer applications using real-time transaction. monitoring.

### SUMMARY

A method for monitoring a computer application according to an embodiment of the present disclosure includes selecting the computer application, inputting condition information, monitoring the computer application and generating an alert when a condition of the computer application satisfies predetermined condition information.

A system for monitoring a computer application according to an embodiment of the present disclosure includes an interface device adapted to allow a user to selected a computer application to be monitored and to input condition information and a monitoring device adapted to monitor the selected computer application, wherein the interface device generates an alert when a condition of the selected computer application satisfies predetermined condition information based on a result of the monitoring performed by the monitoring device.

A computer system according to an embodiment of the present disclosure includes a processor and a program storage device readable by the computer system, embodying a program of instructions executable by the processor to perform method steps for monitoring a computer application, the method steps including selecting the computer application, inputting condition information, monitoring the computer application and generating an alert when a condition of the computer application satisfies predetermined condition information.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an example of a computer system capable of implementing the method and system of the present disclosure;

FIG. 2 is a flow chart illustrating a method for monitoring a computer application according to an embodiment of the present disclosure;

FIG. 3 is a flow chart illustrating a step of selecting a computer application according to an embodiment of the present disclosure;

FIG. 4 is a flow chart illustrating a step of inputting condition information according to an embodiment of the present disclosure;

FIG. 5 is a flow chart illustrating a step of monitoring a computer application according to an embodiment of the present disclosure;

FIG. 6 is a flow chart illustrating a step of generating an alert according to an embodiment of the present disclosure;

FIG. 7 is a block diagram illustrating a system of monitoring a computer application according to an embodiment of the present disclosure;

FIG. 8 is a block diagram illustrating a monitoring device according to an embodiment of the present disclosure; and

FIG. 9 is an example of an agent and server according to the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

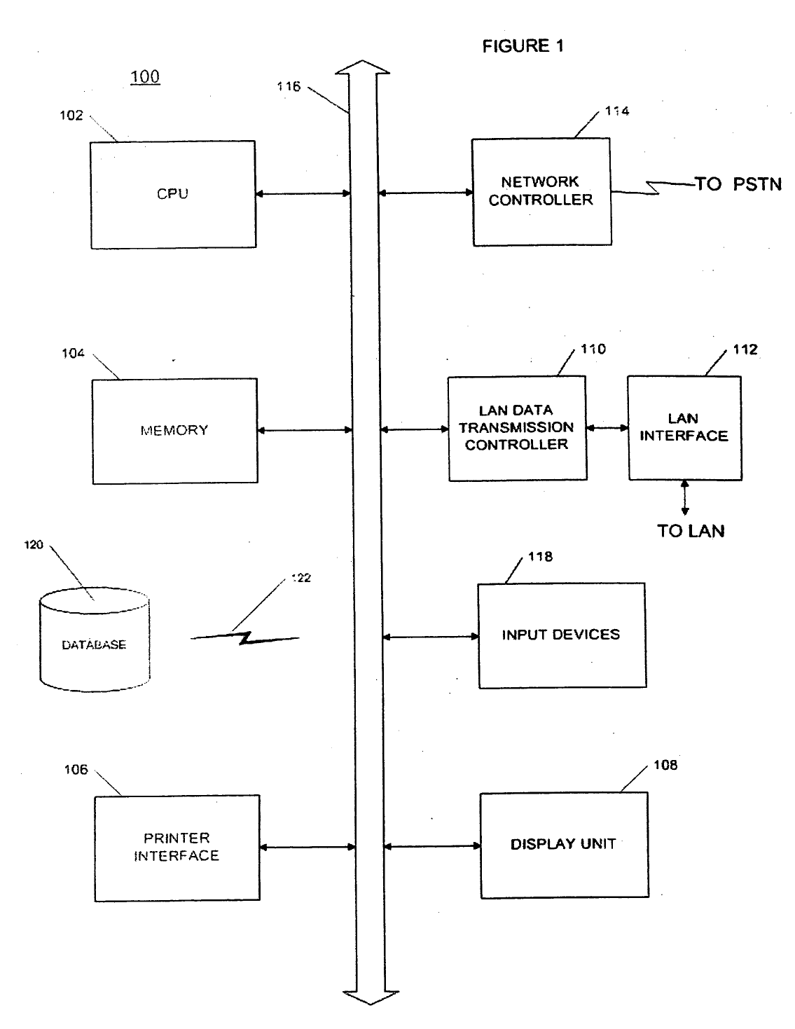

FIG. 1 shows an example of a computer system which may implement the method and system of the present disclosure. The system and method of the present disclosure may be implemented in the form of a software application running on a computer system, for example, a mainframe, personal computer (PC), handheld computer, server etc. The software application may be stored on a recording media locally accessible by the computer system, for example, floppy disk, compact disk, hard disk, etc., or may be remote from the computer system and accessible via a hard wired or wireless connection to a network, for example, a local area network or the Internet.

An example of a computer system capable of implementing the present method and system is shown in FIG. 1. The computer system referred to generally as system 100 may include a central processing unit (CPU) 102, memory 104, for example, Random Access Memory (RAM), a printer interface 106, a display unit 108, a (LAN) local area network data transmission controller 110, in LAN interface 112, a network controller 114, an internal bus 116 and one or more input devices 118, for example, a keyboard, mouse etc. As shown, the system 100 may be connected to a data storage device, for example, a hard disk, 120, via a link 122.

The system and method of the present disclosure invention relate to the area of Information Technology (IT) management. Traditional IT management monitors networks, machines and operating systems, but may not monitor a customer's customized application software. The system and method of the present disclosure complement traditional IT management solutions by providing performance monitoring for EJBs and Servlets that make up the customer's customized application software.

The system and method of the present disclosure provide a management solution with an internal view of the application in order to manage the transactional availability and performance of the application from a synthetic perspective and/or a real time perspective. Since the system and method provide for real-time monitoring of even customized applications, the system and method may detect performance or availability problems of an offending Java Bean home or remote interface, a servlet, or a database connection.

The system and method of the present disclosure provide for monitoring and management of real-time and application specific transactions from a health and performance standpoint. More specifically, the system and method enable monitoring of transactions within the context of a servlet, an EJB or a connection pool.

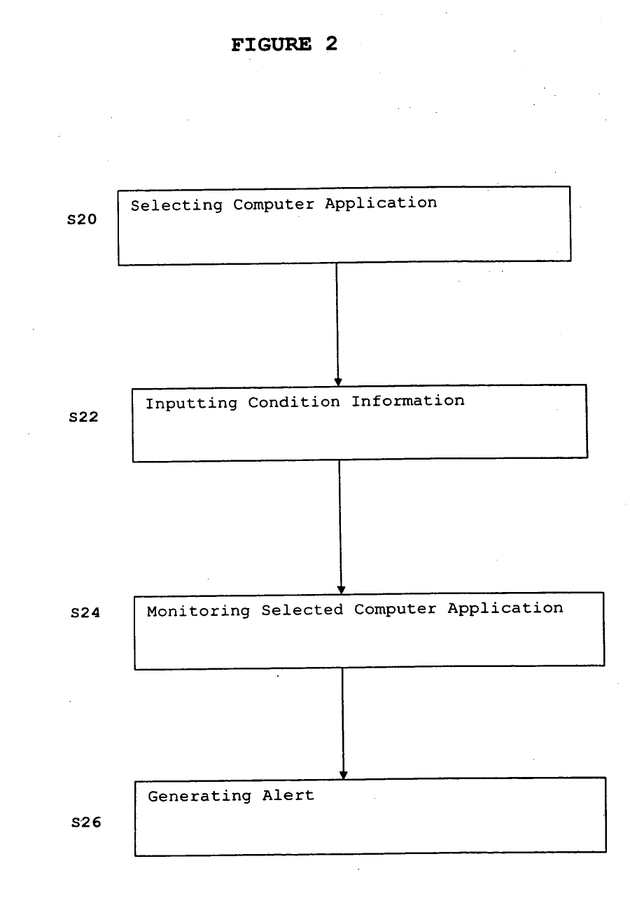

A method for monitoring a computer application according to an embodiment of the present disclosure is illustrated in FIG. 2. The method includes selecting the computer application to be monitored, S20, inputting condition information, S22, monitoring the computer application, S24 and generating an alert when a condition of the selected computer application satisfies predetermined condition information, S26.

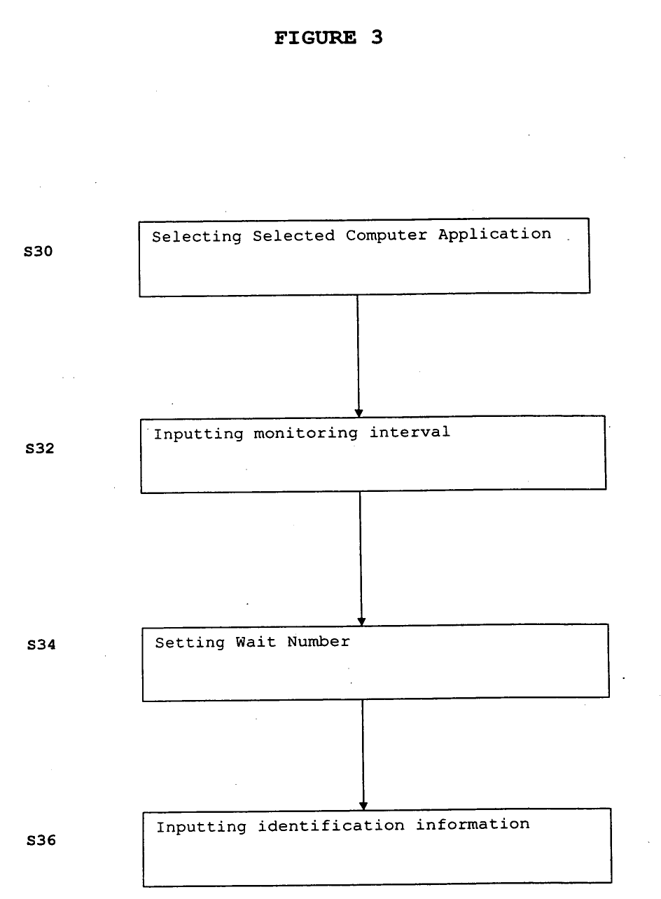

At step S20, the application to be monitored is selected by a user. Where the user knows the application that is to be monitored, the user may simply enter the application via an input device, such as a keyboard. The application may be an enterprise java bean or a servlet, for example. FIG. 3 illustrates a flow chart of the selecting step according to an embodiment of the present disclosure. At step S30, the computer application to be monitored is selected. This may be done via a keyboard as noted above, or the computer application maybe selected from a list of computer applications available for monitoring via a user interface, which will be described in more detail below. The computer application may be an enterprise java bean or a servlet. A monitoring interval indicating a period of time that the computer application is to be monitored maybe identified in step S32. A wait number indicating a number of monitoring intervals during which a status of the application remains in a state prior to generating the alert may be input at step S34. That is, the alert may be generated only after the predetermined condition information is satisfied for multiple monitoring intervals, thus, indicating a more persistent problem. Identification information regarding individuals to be alerted by the alert if and when it is generated may be entered at step S36. That is, at step S36 individuals to whom the alert should be sent are identified.

Steps S30 to S36 may be implemented via direct input of information via an input device, such as a keyboard or mouse, or may be implemented using a graphical user interface. In such an embodiment a list of all servers running computer applications of interest to the user may be displayed to the user. After the user selects a server, a list of all computer applications running on that server may be displayed to the user. The user may then select the desired application without knowing in advance the exact name or location of the application to be monitored. The graphical user interface may also provide prompts to enter monitoring interval, the wait number and the information regarding individuals whom the alert is sent.

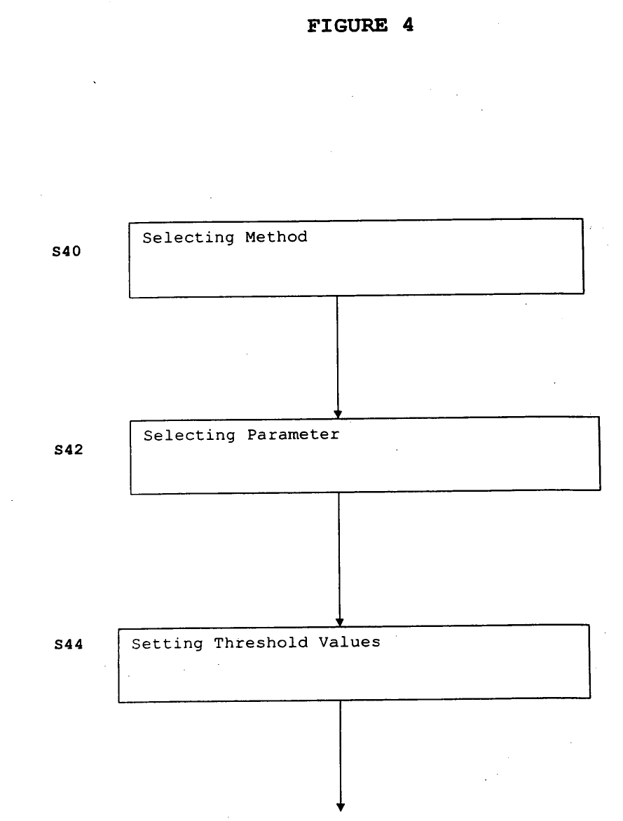

The step of inputting condition information, S22, is further described with reference to FIG. 4. At step S40, the user may select a specific method implemented by the selected computer application to be monitored. It is noted that a computer application may include several methods and each one may be monitored. At step S42, the user may select at least one event, or parameter, of a plurality of parameters related to the selected method. These parameters may include an average execution time for the method during the monitoring interval, a maximum execution time for the method during the monitoring interval, a minimum execution time for the method during the monitoring interval, a method invocation count indicating how many times the method was invoked during the monitoring period and a method thread count indicating the number of threads invoking the method during the monitoring interval. The user may select all parameters or may select one or more of these parameters for monitoring.

The user may set threshold values to establish a status of the method or application with regard to each of these parameters in step S44. That is, for each selected parameter, the user may set a threshold value or values indicating various states of the application. For example, for the average execution time parameter, the status is normal provided that the average execution time is not above a predetermined first threshold, or a warning level. A warning status results if the average execution time is between the first threshold and a second threshold, a minor level. Major status is designated if the average execution time is between the second threshold and a third threshold, a critical value. The status is designated critical if the average execution time is above the third threshold. Each of the parameters may have different first, second and third threshold values. Thus, a first threshold value for the average execution time event may be different than a first threshold value for the maximum execution time event.

Steps S40 to S44 may also be implemented via graphical user interface. The user may choose a selected method to be monitored from a list of several methods performed in the selected computer application. The user may select at least one parameter related to the selected method. The user may then input the first, second and third threshold levels for each selected parameter via the graphical user interface.

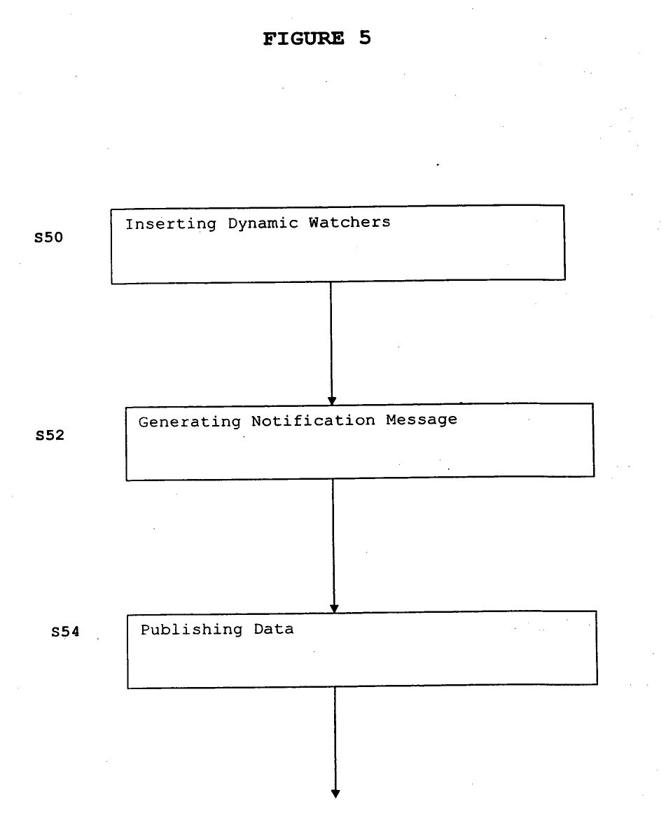

The step of monitoring the computer application is further described with reference to FIG. 5. In step S50, dynamic watchers are inserted into the byte code of the computer application. The dynamic watchers do not alter the application code or affect performance of the application, but merely monitor the application for the occurrence of certain events. At step S52 a notification message is generated upon occurrence of each of the events. In a preferred embodiment the dynamic watcher generates a notification message when: (1) the application is loaded, (2) the execution of the method begins, (3) the execution of the method ends and (4) the method is accessed by a thread. The notification message may include data indicating a type of the application, such as an enterprise java bean or servlet, a thread ID indicating the thread that invoked the application, the name of the application and time information indicating the start time or end time of the method. Since the dynamic watchers are inserted in the byte code of the application itself, the notification messages generated by the dynamic watcher provide real-time information on the functioning of the computer application. The real time information is useful in that it illustrates the actual condition of the server on which the application is running.

At step S54 the data included in the notifications generated by the dynamic watcher may be published. That is, the data may be sent outside of the selected application being monitored to be evaluated to determine whether an alert should be generated in the generating step, S26.

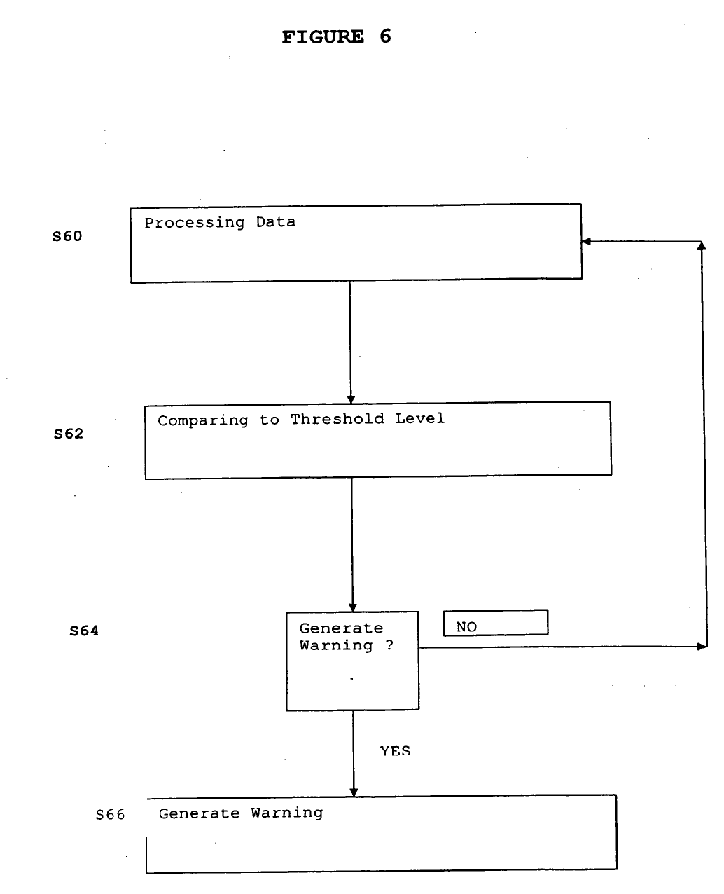

The step of generating an alert, S26, is further described with reference to FIG. 6. In step S60, the data included in the notification messaged generated by the dynamic watcher or watchers is processed to determine a value for the selected parameters. Any parameter selected for monitoring in step S22 of FIG. 2 can be determined using the data included in the notification message, although this may require combining data from more than one notification message. For example, a first notification message may indicate a start time of a method, while another notification message may indicate the end time of the method. The two notification messages together can be used to determine the execution time of the method. In order to determine whether this execution time is a minimum execution time or a maximum execution time, the execution time should be compared to other execution times determined during the monitoring interval.

In step S62, the value of each selected parameter is compared to the threshold level or levels associated with each of the selected parameters to provide an indication of the status of the application with respect to the selected parameter. At step S64 a determination is made as to whether the status or condition of the application satisfies the condition information. More specifically, based on the status of each of the parameters with relation to the threshold levels associated therewith, a determination is made regarding generating the alert. For example, if the average execution time has a status of critical, this likely indicates a problem and an alert should be generated, Yes at S64. The alert is then generated at step S66. On the other hand where the status of each parameter is normal, no alert need be generated, No at step S64. In this case, no alert need be generated and the process may return to step S60 to process data included in notification messages from the next monitoring interval, for example. The user may designate the status of the computer application under which the alert is generated.

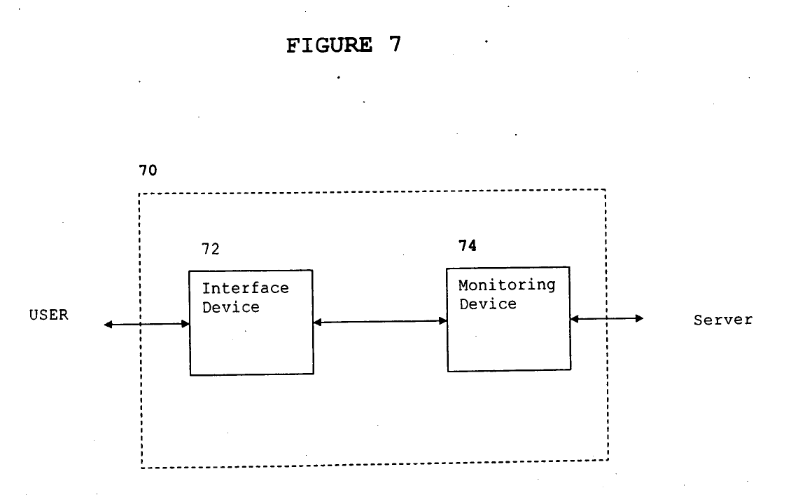

A system 70 for monitoring a computer application according to the present application is described with reference to FIG. 7. An interface device 72 is adapted to allow a user to select the computer application to be monitored and to input condition information. A monitoring device 74 is adapted to monitor the computer application. The interface device 72 may also generate an alert when the condition of the computer application matches predetermined condition information.

The interface device 72 may be implemented as a graphical user interface allowing the user to easily input selection and condition information. According to one embodiment of the present application, the interface device 72 allows the user to input selection information to select a server on which a desired computer application is running. The user may then select at least one specific computer application from a plurality of computer applications running on the server to be monitored. The user may also provide a monitoring interval indicating a period of timer during which the computer application is monitored and may set a wait number indicating the number of monitoring periods during which the condition of the. server satisfies the predetermined condition information prior to generating the alert. As noted above, it may be advantageous to wait prior to generating the alert to ensure that any problem in performance of the application is persistent. The user may also provide identification information indicating individuals to whom the alert is sent when and if the alert is generated.

The condition information input by the user may include information selecting at least one method of a plurality of methods implemented by the selected computer application for monitoring. The user may also select at least one of a plurality of parameters related to the method to be monitored. These parameters include an average execution time for the method during the monitoring interval, a maximum execution time for the method during the monitoring interval, a minimum execution time for the method during the execution time, a method invocation count indicating a number of times the method is invoked during the monitoring interval and a method thread count indicating a number of threads handling a method request during the monitoring interval. The interface device 72 also allows the user to input at least one threshold level for each of the selected parameters for determining a status of the computer application. In a preferred embodiment, several threshold levels are established for each of the parameters. A status may be associated with each of these threshold levels. Normal status may be designated when the parameter is below a first threshold level, referred to as a warning level. A warning status results if the value of the parameter is between the first threshold level and a second threshold, referred to as a minor level. Major status is designated if the value of the parameter is between the second threshold and a third threshold, referred to as a critical value. The status is designated critical if the value of the parameter is above the third threshold. Each of the parameters may have different first, second and third threshold values. Thus, a first threshold value for the average execution time parameter may be different than a first threshold value for the maximum execution time parameter.

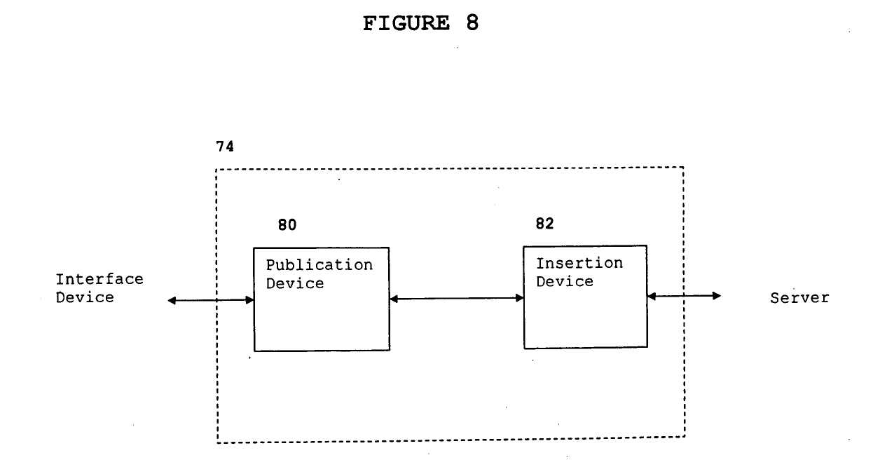

The monitoring device 74 is used to monitor the application. The monitoring device is described in further detail with reference to FIG. 8. An insertion device 80 inserts at least one dynamic watcher into the byte code of the selected application. More specifically, the insertion device 80 may insert at least one dynamic watcher into the byte code of the selected method. The dynamic watcher generates notification messages upon the occurrence of certain events in the computer application. More specifically, the dynamic watcher generates a notification message when (1) the computer application is invoked (2) the selected method starts execution (3) the selected method ends execution and (4) the method is accessed by a thread. The notification message may include data indicating a type of the application, such as an enterprise java bean or servlet, a thread ID indicating the thread that invoked the application, the name of the application and time information indicating the start time or end time of the method.

A publication device 82 is adapted to publish the data included in the notification method. That is the publication device may send data corresponding to the data included in the notification message to the user interface 80. In a preferred embodiment, publication is accomplished by sending the data to the interface device 80 using UserDatagram Protocol. More specifically, a datagram including the data included in the notification message may be sent from the publishing device 82 to the interface device 72 for each notification message generated by the at least one dynamic watcher.

The user-interface 72 may then process the data included in the notification message to determine values for each of the selected parameters. This determination may require collection of data from several notification messages. For example, a notification message is generated upon the beginning of execution of selected method and another notification message may be generated upon ending execution of the selected method. Thus, based on these two notification messages the execution time may be determined. In addition, in order to determine an average execution time it is necessary to average the execution time of all invocations of the selected method during the monitoring interval. The value of each selected parameter may then be compared to the threshold level or levels associated with each selected parameter in order to determine a status of the computer application. Based on the status, the interface device 70 may generate the alert. The alert may then be sent to an individuals identified via the interface device. For example, if a value of the average execution time is above the third threshold level, the status of the computer application is critical. This may indicate a serious problem in the execution of the computer application and the alert is generated. However, where the value of each of the selected parameters below the first threshold level for each parameter, the computer application is functioning normally and the alert need not be generated. The user may designate the status of each parameter under which the alert is to be generated.

It is noted that the system for monitoring a computer application substantially implements the method for monitoring a computer application discussed above.

In a specific embodiment of the present application, the system for monitoring a computer application may be implemented as a plug-in into the Application Server of and interface with the Unicenter Management for J2EE Agent, for example. In a preferred embodiment, a user interface allows the user to monitor the performance of selected applications, such as EJB's and servlets deployed within the application server. More specifically, the user interface may employ a form which may contain a single object representing a Weblogic Insider Expert Agent, or Agent. The form shows the Weblogic deployed servlet or EJB, that is, the selected application that the Expert Agent is monitoring. Servlets or EJBs to be monitored may be added, modified and removed. Only the servlets and EJBs deployed within the Weblogic servers being monitored by the same Agent may be allowed.

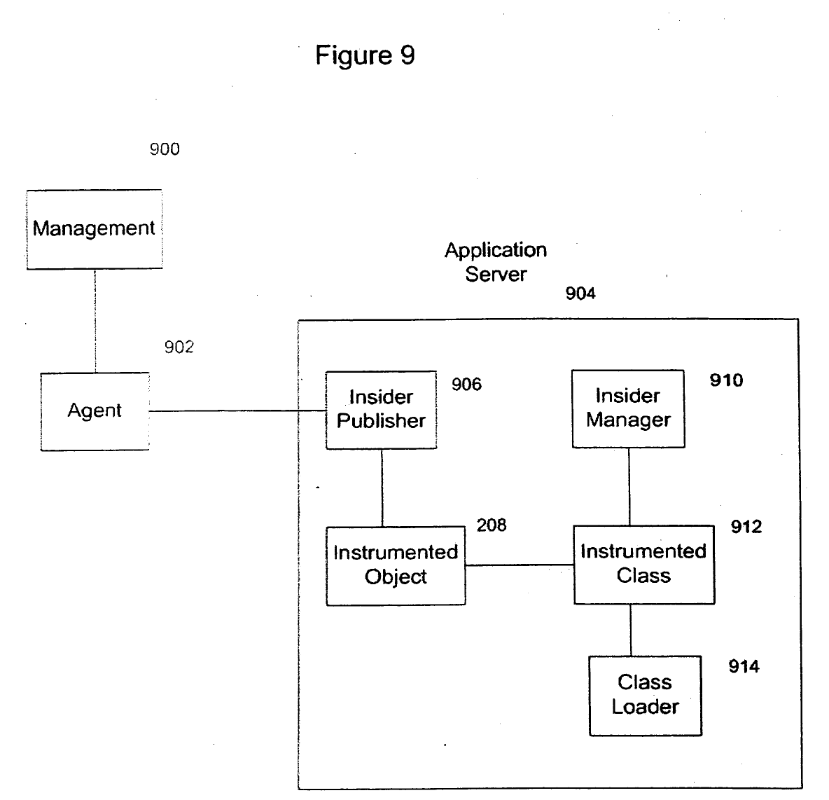

FIG. 9 shows an example of an Agent and server according to the present disclosure. A Management block 200, such as Unicenter Management for Weblogic, WebSphere or Oracle9iAS, is shown connected to an Agent 202, which connects with an Insider Publisher 206 within an Application Server 204. Insider Publisher 206 connects with an Instrumented Object 208, which connects with an Instrumented Class 212 which connects with both and, Insider Manager 210 and a Class Loader 214.

Insider, that is the Insider Manager and the Insider Publisher together, work as an instrumentation agent for Agent. It may run in Application Server's Java Virtual Machine (JVM) which is where all EJB and servlets are run. Agent may communicate with Insider using User Datagram Protocol (UDP) publish/subscribe model. Insider architecture may be divided into two parts, byte code instrumentation and publishing instrumentation to publish data to Agent.

As a class, or application, gets loaded in the JVM, Insider may intercept it and inserts dynamic watchers into these class files. As EJBs, JSPs/Servlets and stand alone java classes get loaded in the JVM, Insider may instrument the byte code by inserting dynamic probes or watchers.

Insider may publish data to Agent by two methods. The first method is a UDP Publish/Subscribe method, where Insider opens a UDP Socket on the application server. For every notification message received from byte code instrumentation it may send out a datagram packet. The second method is a CASM EJB method where CASM EJB acts as a request response service. Agent uses this service to get the metadata of the instrumented objects, or monitored applications. This service may also dynamically start and stop publishing of data.

The present system and method thus provides an efficient and convenient way for an administrator to configure and modify one or more computer systems.

The present disclosure may be conveniently implemented using one or more conventional general purpose digital computers and/or servers programmed according to the teachings of the present specification. Appropriate software coding can readily be prepared by skilled programmers based on the teachings of the present disclosure. The present disclosure may also be implemented by the preparation of application specific integrated circuits or by interconnecting an appropriate network of conventional components.

Numerous additional modifications and variations of the present disclosure are possible in view of the above-teachings. It is therefore to be understood that within the scope of the appended claims, the present disclosure may be practiced other than as specifically described herein.

What is claimed is:

1. A method for monitoring a computer application comprising:
selecting the computer application;
inputting condition information;
monitoring the computer application; and
generating an alert when a condition of the computer application satisfies predetermined condition information.

2. The method of claim 1, wherein the computer application is selected based on selection information input by a user via a user interface.

3. The method of claim 2, wherein the computer application is one of an enterprise java bean and a servlet.

4. The method of claim 3 wherein the selecting step further comprises:
selecting a server on which the computer application operates;
selecting at least one computer application from a plurality of computer applications running on the selected server to be monitored;
inputting a monitoring interval indicating a period of time during which the computer application is monitored; and
inputting a wait number indicating a number of monitoring intervals during which the condition of the computer application satisfies the predetermined condition information prior to generating the alert.

5. The method of claim 4, wherein the step of inputting condition information further comprises:
selecting at least one method of a plurality of methods performed by the selected computer application to be monitored.

7. The method of claim 6, wherein the step of inputting condition information further comprises:
selecting at least one parameter of a plurality of parameters related to the selected method to be monitored, wherein the plurality of parameters includes an average execution time of the method during the monitoring interval, a minimum execution time of the method during the monitoring interval, a maximum execution time of the method during the monitoring, interval, a method invocation count indicating a number of times the method is invoked during the monitoring interval and a method thread count indicating a number of threads handling a method request during the monitoring interval.

8. The method of claim 7, wherein the step of inputting condition information further comprises:
inputting at least one threshold level for determining a status of the at least one selected parameter.

9. The method of claim 8, wherein the monitoring step further comprises inserting at least one dynamic watcher into byte code of the computer application to monitor the computer application, wherein the dynamic watcher generates a notification message upon detection of any one of a plurality of events in the computer application.

10. The method of claim 9, wherein the plurality of events includes loading the computer application, starting the selected method of the computer application, ending the selected method of the computer application and accessing the method via a thread.

11. The method of claim 10, wherein the notification message generated by the dynamic probe includes data indicating a type of the computer application, a thread ID indicating the identity of the thread that invoked the computer application, a name indicating a name of the computer application invoked, and time information including one of a start time and an end time of the selected method of the computer application.

12. The method of claim 11, wherein the monitoring step further comprises:
publishing the data included in the notification message generated by the dynamic watcher.

13. The method of claim 12 wherein the generating step further comprises:
processing the data included in the notification message to determine a value for each of the selected parameters;
comparing the value of each of the selected parameters to the at least one threshold level of the selected parameter to determine a status of the computer application; and
generating the alert when the status of the computer application indicates that the alert is to be generated.

14. A system for monitoring a computer application comprising:
an interface device adapted to allow a user to select a computer application to be monitored and to input condition information; and
a monitoring device adapted to monitor the selected computer application, wherein the interface device generates an alert when a condition of the selected computer application determined based on a result of the monitoring performed by the monitoring device satisfies predetermined condition information.

15. The system of claim 14, wherein the interface device comprises a graphical user interface allowing a user to input information.

16. The system of claim 15, wherein the interface device allows the user to select a server running a plurality of computer applications and to select at least one computer application from the plurality of computer applications running on the selected server to be monitored and to input a monitoring interval indicating a period of time during which the selected computer application is to be monitored.

17. The system of claim 16, wherein the interface device allows the user to input a waiting number indicating a number of monitoring intervals during which the condition of the computer application satisfies the predetermined condition information prior to generating the alert.

18. The system of claim 17, wherein the condition information comprises method information indicating at least one method of a plurality of method used by the selected computer application to be monitored, parameter information indicating at least one parameter of a plurality of parameters related to the selected method to be monitored and threshold information indicating at least one threshold level for the at least one selected parameter for determining the status of the computer application.

19. The system of claim 18, wherein the plurality of parameters includes an average execution time of the method during the monitoring interval, a minimum execution time of the method during the monitoring interval, a maximum execution time of the method during the monitoring interval, a method invocation count indicating a number of times the method is invoked during the monitoring interval and a method thread count indicating a number of threads handling a method request during the monitoring interval.

20. The system of claim 19, wherein the monitoring device further comprises:
an insertion device adapted to insert dynamic watchers into the byte code of the selected computer application, wherein the dynamic watchers generate a notification message upon occurrence of each of a plurality of events in the computer application; and
a publication device adapted to publish data included in the notification messages to the interface device.

21. The system of claim 20, wherein the plurality of events comprise loading of the computer application, beginning execution of the selected method, ending execution of the selected method and accessing of the computer application by a thread.

22. The system of claim 21, wherein the notification message comprises data indicating a type of the selected computer application, a thread ID indicating the identity of the thread that invoked the computer application, a name indicating a name of the selected computer application invoked, and time information including one of a start time and an end time of the selected method of the computer application.

23. The system of claim 22, wherein the publication device sends data corresponding to each notification message generated by the at least one dynamic watcher to the interface device.

24. The system of claim 23, wherein the interface device processes the data corresponding to each notification message to determine a value for each selected parameter and compares the value of each selected parameter to the threshold value the selected parameter to determine a status of the computer application.

25. The system of claim 24, wherein the interface device generate the alert when the status of the computer application is a predetermined status.

26. A computer system comprising:
a processor; and
a program storage device readable by the computer system, embodying a program of instructions executable by the processor to perform method steps for monitoring a computer application, the method steps comprising:
selecting the computer application;
inputting condition information;
monitoring the computer application; and
generating an alert when a condition of the computer application satisfies predetermined condition information.

27. The computer system of claim 26, wherein the computer application is selected based on selection information input by a user via a user interface.

28. The computer system of claim 27, wherein the computer application is one of an enterprise java bean and a servlet.

29. The computer system of claim 28, wherein the selecting step further comprises:
selecting a server on which the computer application operates;
selecting at least one computer application from a plurality of computer applications running on the selected server to be monitored;
inputting a monitoring interval indicating a period of time during which the computer application is monitored; and
inputting a wait number indicating a number of monitoring intervals during which the condition of the computer application satisfies the predetermined condition information prior to generating the alert.

30. The computer system of claim 29, wherein the step of inputting condition information further comprises:
selecting at least one method of a plurality of methods performed by the selected computer application to be monitored.

31. The computer system of claim 30, wherein the step of inputting condition information further comprises:
selecting at least one parameter of a plurality of parameters related to the selected method to be monitored, wherein the plurality of parameters includes an average execution time of the method during the monitoring interval, a minimum execution time of the method during the monitoring interval, a maximum execution time of the method during the monitoring interval, a method invocation count indicating a number of times the method is invoked during the monitoring interval and a method thread count indicating a number of threads handling a method request during the monitoring interval.

32. The computer system of claim 31, wherein the step of inputting condition information further comprises:
inputting at least one threshold level for the at least one selected parameter for determining a status of the computer application.

33. The computer system of claim 32, wherein the monitoring step further comprises inserting at least one dynamic watcher into byte code of the computer application to monitor the computer application, wherein the dynamic watcher generates a notification message upon detection of any one of a plurality of events in the computer application.

34. The computer system of claim 33, wherein the plurality of events includes loading the computer application, starting the selected method of the computer application, ending the selected method of the computer application and accessing the method via a thread.

35. The computer system of claim 34, wherein the notification message generated by the dynamic probe includes data indicating a type of the computer application, a thread ID indicating the identity of the thread that invoked the computer application, a name indicating a name of the computer application invoked, and time information including one of a start time and an end time of the selected method of the computer application.

36. The computer system of claim 35, wherein the monitoring step further comprises:
publishing the data included in the notification message generated by the dynamic watcher.

36. The computer system of claim 35, wherein the generating step further comprises:
processing the data included in the notification message to determine a value for each of the selected parameters;
comparing the value of each of the selected parameters to the at least one threshold level of the selected parameter to determine a status of the computer application; and
generating the alert when the status of the computer application indicates that the alert is to be generated.
